(19) United States
(12) Patent Application Publication
(10) Pub. No.: US 2018/0102555 A1
(43) Pub. Date: Apr. 12, 2018

(54) GASKET FOR FUEL CELL

(71) Applicant: HYUNDAI MOTOR COMPANY, Seoul (KR)

(72) Inventors: Seong Il HEO, Yongin-si (KR); Yil Hoon YI, Busan (KR); Byeong-Heon JEONG, Yongin-si (KR)

(73) Assignee: HYUNDAI MOTOR COMPANY, Seoul (KR)

(21) Appl. No.: 15/374,999

(22) Filed: Dec. 9, 2016

(30) Foreign Application Priority Data
Oct. 12, 2016 (KR) 10-2016-0131821

(51) Int. Cl. H01M 8/0276

(52) U.S. Cl. CPC H01M 8/0276

(57) ABSTRACT

Disclosed herein is a gasket for a fuel cell, which is coupled to surfaces of a pair of separators disposed above and below an MEA. The gasket for a fuel cell includes a first gasket coupled to the surface of one of the separators while one surface of the first gasket comes into contact therewith, the other surface of the first gasket being an irregular surface, and a second gasket coupled to the surface of the other of the separators.

### CROSS REFERENCE TO RELATED APPLICATION

The present application claims priority of Korean Patent Application No. 10-2016-0131821 filed on Oct. 12, 2016, the entire contents of which is incorporated herein for all purposes by this reference.

### BACKGROUND

### Field

The present invention relates to a gasket for a fuel cell, and, more particularly, to a gasket for a fuel cell, capable of enhancing airtightness and safety by having an irregular shape to disperse the contact pressure of the gasket and by allowing a cathode-side gasket and an anode-side gasket to have different hardness.

### Description of the Related Art

A fuel cell is a type of generator unit which converts chemical energy derived from fuel into electrical energy by electrochemical reaction in a stack. Fuel cells may be used to supply driving power to industrial equipment, home appliances, and vehicles, and to supply power to compact electronic devices such as portable devices. In recent years, these fuel cells are high-efficiency clean energy sources and have been increasingly used in various fields.

FIG. 1 is a cross-sectional view schematically illustrating a fuel cell stack. As illustrated in FIG. 1, the fuel cell stack includes an MEA (Membrane Electrode Assembly) 10 having a catalyst layer, in which hydrogen reacts with oxygen, and separators 20 disposed on both sides of the MEA 10 to supply hydrogen and oxygen into the MEA 10 and simultaneously facilitate discharge of water.

In this case, both sides of each of the separators 20 are provided with a plurality of manifolds through which air and coolant may flow when the separator is stacked. Gaskets for a fuel cell 30 are arranged along the edge of the separator 20 and the manifolds.

The gaskets for a fuel cell 30 serve as guides such that hydrogen and air introduced thereinto may respectively move to a hydrogen catalyst layer and an air catalyst layer of the MEA 10, and simultaneously maintain airtightness so as to prevent substances flowing along each of the manifolds from moving to a manifold adjacent thereto.

FIG. 2 is a view illustrating a result of analyzing the contact pressures of gaskets for a fuel cell when the fuel cell of FIG. 1 is assembled.

As illustrated in FIG. 2, gaskets for a fuel cell 30, each having a square cross-section, are made of the same material, regardless of the positions thereof, and have a structure in which contact pressures are concentrated on both ends of the gaskets. For this reason, the gaskets may be vulnerable to airtightness and safety at room temperature and low temperature and may be permanently deformed at high temperature due to the lack of elastic restoring force.

The disclosure of this section is to provide background of the invention. Applicant notes that this section may contain information available before this application. However, by providing this section, Applicant does not admit that any information contained in this section constitutes prior art.

### SUMMARY

Accordingly, the present invention has been made keeping in mind the above problems occurring in the related art, and the present invention is intended to propose a gasket for a fuel cell, capable of enhancing airtightness by dispersing the contact pressure of the gasket and of preventing permanent deformation at high temperature by an improved structure.

In accordance with an aspect of the present invention, a gasket for a fuel cell, coupled to surfaces of a pair of separators disposed above and below an MEA, includes a first gasket coupled to the surface of one of the separators while one surface of the first gasket comes into contact therewith, the other surface of the first gasket being an irregular surface, and a second gasket coupled to the surface of the other of the separators.

The second gasket may have a greater width than the first gasket.

The first gasket may include a gasket body coupled to the surface of the separator, and a plurality of protrusions protruding from a surface of the gasket body while being spaced apart from each other in a width direction.

Each of the protrusions may have a larger thickness than the gasket body. A distance between the adjacent protrusions may be 0.2 times or more a distance between centers of the adjacent protrusions.

The first gasket may have a higher hardness than the second gasket.

As apparent from the above description, since the first gasket coming into contact with both surfaces of the cathode separator has a plurality of protrusions formed at intervals along the airtight line, it is possible to enhance airtightness and minimize deformation by dispersing contact pressures.

In addition, it is possible to minimize a pushing phenomenon between unit cells of the fuel cell and lateral separation of the cathode and anode separators, compared to a conventional structure.

Furthermore, since the first and second gaskets coming into contact with the respective cathode and anode separators are made of different materials, it is possible to further improve airtightness.

### BRIEF DESCRIPTION OF THE DRAWINGS

The above and other features and advantages of the present invention will be more clearly understood from the following detailed description taken in conjunction with the accompanying drawings, in which:

FIG. 1 is a cross-sectional view schematically illustrating a conventional fuel cell stack;

FIG. 2 is a view illustrating a result of analyzing the contact pressures of conventional gaskets for a fuel cell;

FIG. 3 is a view for explaining a gasket for a fuel cell according to an embodiment of the present invention;

FIG. 4 is a view illustrating a result of analyzing the contact pressures of the gasket for a fuel cell according to an embodiment of the present invention;

FIG. 5 is a view for explaining a first gasket according to an embodiment of the present invention;

FIGS. 6 and 7 are graphs illustrating a result of measuring inter-unit cell pushing and lateral separation force in a fuel cell stack to which a conventional gasket for a fuel cell and a gasket for a fuel cell according to various examples of the present invention are applied;

FIG. 8 is a view illustrating a contact pressure in the airtight line of a conventional gasket for a fuel cell;

FIG. 9 is view illustrating a contact pressure in the airtight line of the gasket for a fuel cell according to an embodiment of the present invention; and

FIG. 10 illustrates a gasket of a fuel cell according to an embodiment of the invention.

### DESCRIPTION OF EMBODIMENTS

Embodiments of the present invention will be described below in more detail with reference to the accompanying drawings. The present invention may, however, be embodied in different forms and should not be construed as limited to embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present disclosure is characterized in that gaskets, which are respectively coupled to a pair of separators disposed above and below an MEA (Membrane Electrode Assembly), have different structures and materials, thereby simultaneously enhance airtightness and durability by dispersing contact pressures.

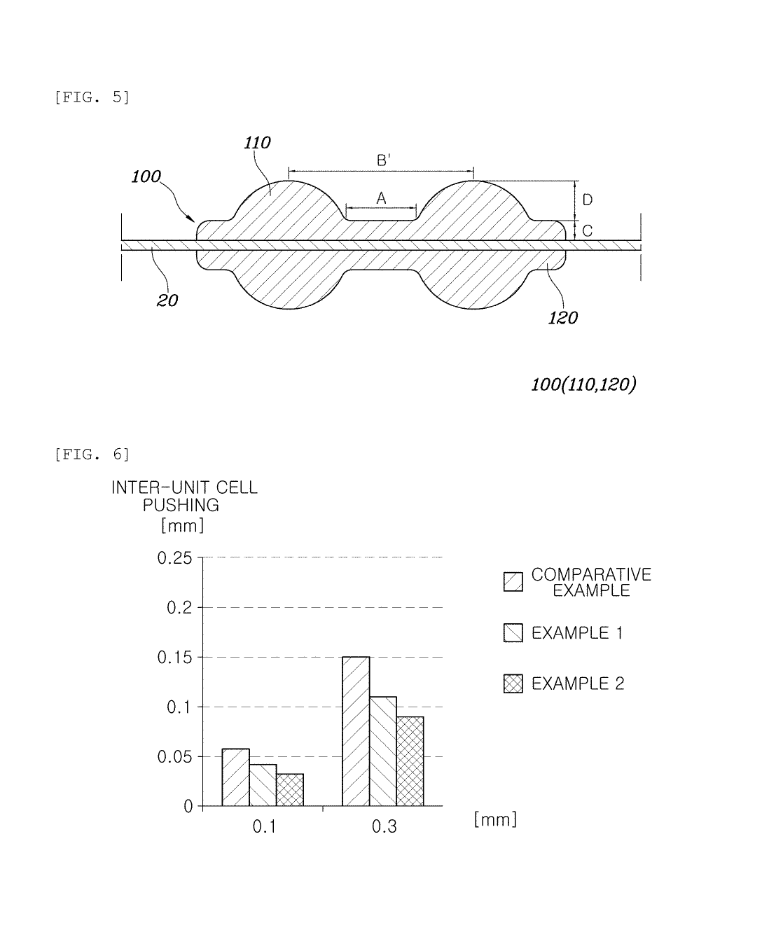

An aspect of the invention provides a gasket of a fuel cell. The gasket has a central opening and a closed-loop periphery. In embodiments, in an assembled fuel cell, the periphery is interposed between two separate parts—a separator and a MEA as illustrated in FIG. 4.

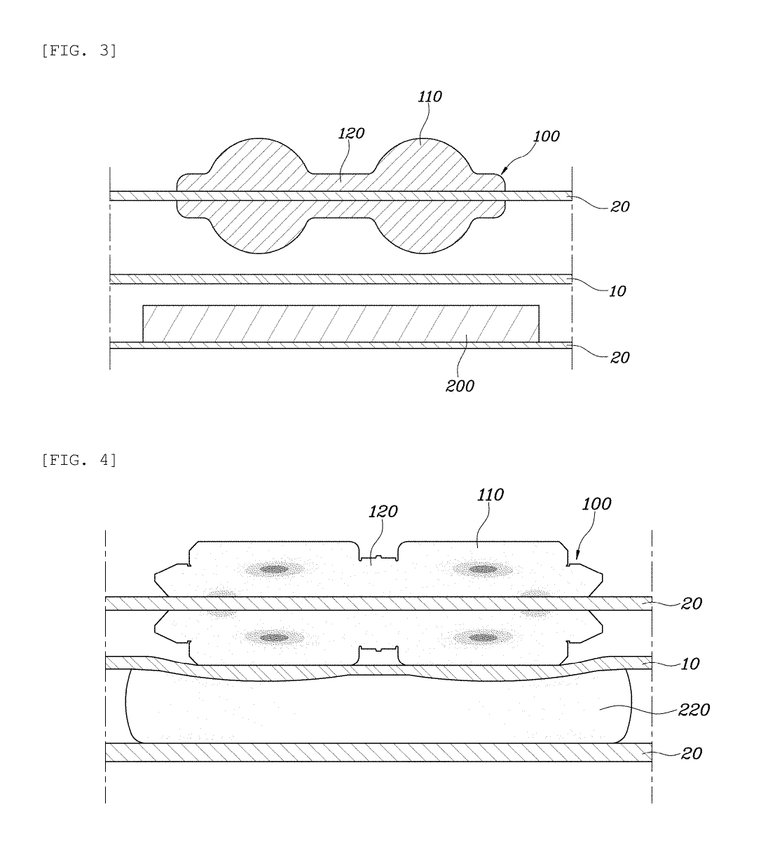

In embodiments, the periphery of the gasket (100 of FIG. 3) has a first surface a second surface facing away from the first surface. The first surface is substantially flat and contacts the separator 20. In the cross-sectional view of FIGS. 3 and 4, the second surface of the periphery has at least two humps. The two humps are laterally distance we dug gap air between.

When the gasket 100 is assembled to MEA 10, the rounded top 110 of the humps is flattened and contacts a surface of the MEA 10 such that the gap between the two humps in the cross-sectional view is shortened.

FIG. 3 is a view for explaining a gasket for a fuel cell according to an embodiment of the present invention. FIG. 4 is a view illustrating a result of analyzing the contact pressures of the gasket for a fuel cell according to embodiments of the present invention.

As illustrated in FIG. 3, the gasket for a fuel cell according to embodiments of the present invention includes first and second gaskets 100 and 200 which are respectively coupled to a cathode and an anode, i.e. to the surfaces of a pair of separators 20 disposed above and below an MEA 10.

The first gasket 100 is coupled to the surface of one of the separators 20, and the second gasket 200 is coupled to the surface of the other of the separators 20.

In this case, it is preferable that one surface of the first gasket 100 be in contact with the surface of the separator 20 while the other surface of the first gasket 100 be configured as an irregular surface formed with a plurality protrusions 110, and both surfaces of the second gasket 200 be flat.

Accordingly, as seen in FIG. 4, the gasket for a fuel cell according to an embodiment of the present invention can minimize a portion, on which a contact pressure is concentrated, by dispersing the contact pressure, compared to a conventional gasket for a fuel cell consisting of a plurality of gaskets having the same structure. Thus, it is possible to improve airtightness.

In addition, it is possible to enhance the durability and life of the gasket for a fuel cell by minimizing the concentration of contact pressures.

In this case, the second gasket 200 according to embodiments of the present invention preferably has a greater width than the first gasket 100.

Through such a structure, the second gasket 200 may sufficiently enclose the protrusions 110 formed on the first gasket 100 when a fuel cell stack is assembled, with the consequence that it is possible to further improve airtightness and facilitate the dispersion of contact pressures.

That is, when the first and second gaskets 100 and 200 are coupled with the MEA 10 interposed therebetween, it is possible to maximize the contact area between the protrusions 110 of the first gasket 100 and the surface of the second gasket 200 to attain the above effect.

FIG. 5 is a view for explaining the first gasket according to an embodiment of the present invention.

As illustrated in FIG. 5, the first gasket 100 according to embodiments of the present invention includes a gasket body 120, one surface of which is coupled to the surface of the separator 20, and a plurality of protrusions 110 formed on the other surface of the gasket body 120 while being arranged at regular intervals in a width direction.

In this case, a thickness C of the gasket body 120 is preferably smaller than a thickness D of each of the protrusions 110.

If the thickness C of the gasket body 120 is larger than the thickness D of the protrusion 110, the repulsive force of the whole gasket of a fuel cell is increased. Hence, the structural safety of the gasket may be deteriorated when the fuel cell stack is assembled.

In addition, the first gasket 100 is preferably configured such that a distance A between the adjacent protrusions 110 is 0.2 times or more a distance B between the centers of the adjacent protrusions 110.

If the distance A between the protrusions is less than 20% of the distance B between the centers of the protrusions, the adjacent protrusions 100 interfere with each other when the fuel cell stack is assembled, which may lead to deterioration of airtightness or to deterioration of durability because stress is concentrated on the interference portion between the protrusions 110. Therefore, it is preferable that the distance between the adjacent protrusions 100 be equal to or more than 20% of the distance B between the centers of the adjacent protrusions 110.

Meanwhile, the first gasket 100 of the present invention is preferably made of a material having high hardness compared to the second gasket 200.

As described above, since the second gasket 200 is deformed to enclose the protrusions 110 of the first gasket 100 with the MEA 10 interposed therebetween, it is possible to improve airtightness and disperse contact pressures by maximizing the contact area between the first gasket 100 and the second gasket 200.

FIGS. 6 and 7 are graphs illustrating a result of measuring inter-unit cell pushing and lateral separation force after a cathode-side gasket and an anode-side gasket are disposed so as to be offset by a distance of 0.1 mm and 0.3 mm, in a fuel cell stack to which a conventional gasket for a fuel cell and a gasket for a fuel cell according to various examples of the present invention are applied.

In this case, in the graphs illustrating a result of measuring inter-unit cell pushing and lateral separation force, a conventional gasket for a fuel cell is used as a comparative example, a gasket for a fuel cell, in which a first gasket 100 has a plurality of protrusions 110 formed on the surface thereof, is used as an example 1 according to embodiments of the present invention, and a gasket for a fuel cell, in which a first gasket 100 has a plurality of protrusions 110 formed on the surface thereof and a second gasket 200 has a greater width than the first gasket 100, is used as an example 2 according to embodiments of the present invention.

First, it can be seen that the inter-unit cell pushing in the example 1, in which the first gasket 100 has the protrusions 110 formed on the surface thereof, is reduced by about 20% or more, compared to the comparative example. Particularly, it can be seen that the inter-unit cell pushing in the example 2, in which the first gasket 100 has the protrusions 110 formed on the surface thereof while the second gasket 200 has an increased width, is reduced by about 40% or more, compared to the comparative example.

In addition, it can be seen that the lateral separation force of a unit cell, i.e. the separation force relative to the direction perpendicular to the direction in which unit cells are stacked, in both examples 1 and 2 is reduced by about 50% or more, compared to the comparative example.

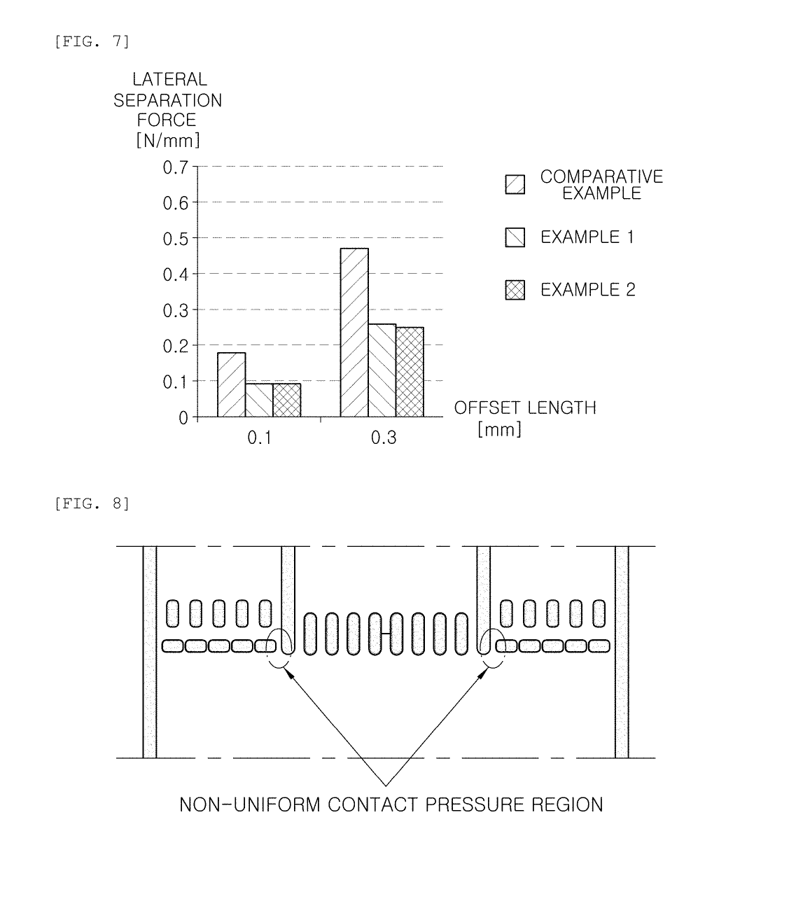

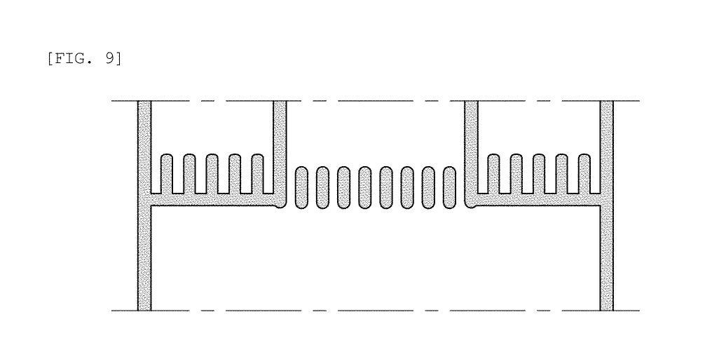

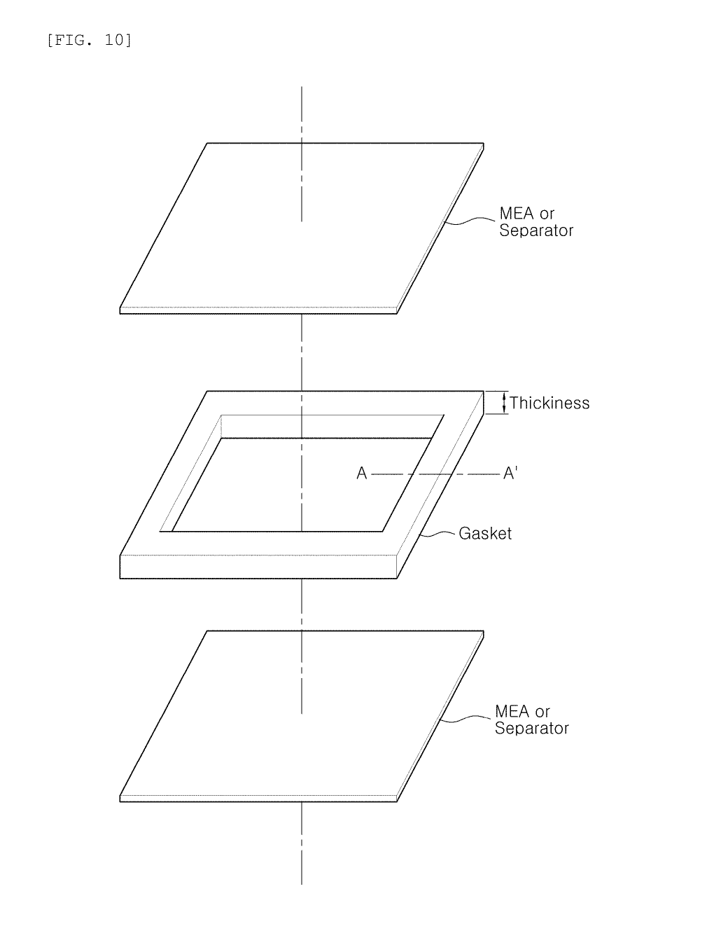

FIG. 8 is a view illustrating a contact pressure in the airtight line of a conventional gasket for a fuel cell. FIG. 9 is view illustrating a contact pressure in the airtight line of the example 2 of the gasket for a fuel cell according to embodiments of the present invention.

As illustrated in FIGS. 8 and 9, it can be seen that non-uniform contact pressure regions locally occur in the airtight line of the conventional gasket for a fuel cell, whereas contact pressures are uniform throughout the airtight line of the gasket for a fuel cell according to the embodiment of the present invention. Therefore, the gasket for a fuel cell according to embodiments of the present invention can have improved airtightness compared to the conventional gasket for a fuel cell.

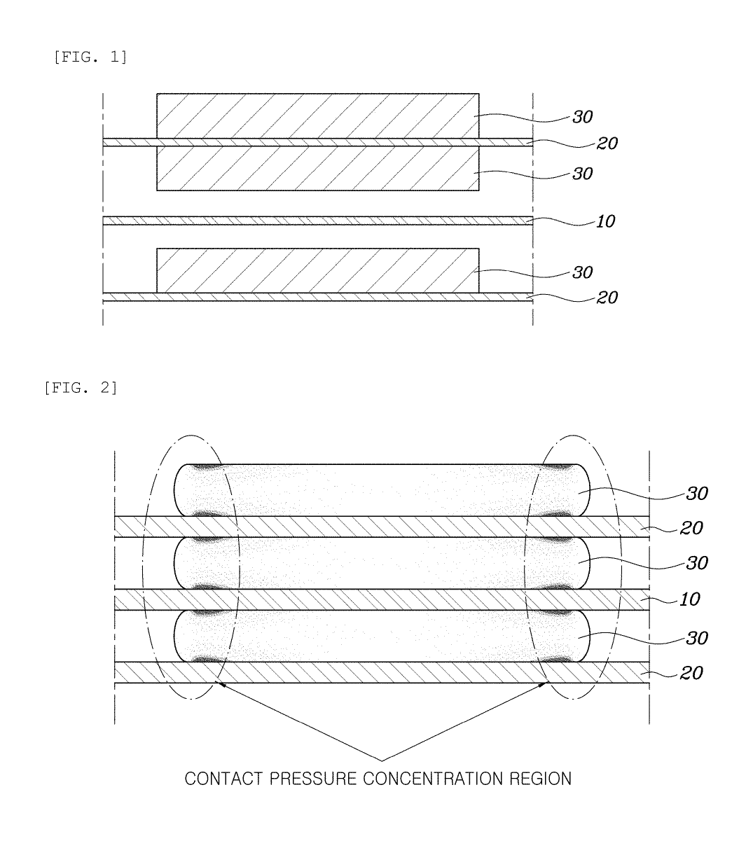

FIG. 10 illustrates a gasket of a fuel cell according to an embodiment of the invention. FIGS. 1 and 3 illustrates cross-sectional views of gaskets that corresponding to a cross-sectional views taken by a plane including the line A-A′ of FIG. 10. Although embodiments of the present invention have been disclosed for illustrative purposes, those skilled in the art will appreciate that various modifications, additions and substitutions are possible.

What is claimed is:

1. A gasket for a fuel cell, coupled to surfaces of a pair of separators disposed above and below an MEA, comprising:
a first gasket coupled to the surface of one of the separators while one surface of the first gasket comes into contact therewith, the other surface of the first gasket being an irregular surface; and
a second gasket coupled to the surface of the other of the separators.

2. The gasket according to claim 1, wherein the second gasket has a greater width than the first gasket.

3. The gasket according to claim 1, wherein the first gasket comprises:
a gasket body coupled to the surface of the separator; and
a plurality of protrusions protruding from a surface of the gasket body while being spaced apart from each other in a width direction.

4. The gasket according to claim 3, wherein each of the protrusions has a larger thickness than the gasket body.

5. The gasket according to claim 3, wherein a distance between the adjacent protrusions is 0.2 times or more a distance between centers of the adjacent protrusions.

6. The gasket according to claim 1, wherein the first gasket has a higher hardness than the second gasket.
